(19) United States
(12) Patent Application Publication
(10) Pub. No.: US 2025/0084894 A1
(43) Pub. Date: Mar. 13, 2025

(54) COMPOSITE STRUT

(71) Applicant: Trelleborg Sealing Solutions Albany, Inc., Niskayuna, NY (US)

(72) Inventors: Brett A. Kimball, Loudonville, NY (US); Robert J. Langone, Clifton Park, NY (US); David E. Hauber, Troy, NY (US)

(73) Assignee: Trelleborg Sealing Solutions Albany, Inc., Niskayuna, NY (US)

(21) Appl. No.: 18/463,619

(22) Filed: Sep. 8, 2023

(51) Int. Cl. F16C 7/02

(52) U.S. Cl. CPC F16C 7/026

(57) ABSTRACT

A composite strut includes a first end and first aperture opposite a second end and second aperture separated by a strut distance along a longitudinal axis. A compression block is disposed between the first and the second aperture. A tension strap has a first continuous fiber reinforced plastic composite wrapped repeatedly around the first aperture, along the top side of the compression block, around the second aperture and along the bottom side of the compression block at least two times, wherein fibers of the tension strap are oriented extending parallel to the longitudinal axis between the first and second apertures. An overwind has a second continuous fiber reinforced plastic composite wrapped repeatedly around the first continuous fiber reinforced plastic composite and the compression block between the first end and second end at least two times, wherein fibers of the overwind are oriented extending around the longitudinal axis.

### CROSS-REFERENCE TO RELATED APPLICATIONS

None.

### DESCRIPTION

### Field of the Invention

The present invention generally relates to struts. More particularly, the present invention relates to a lightweight strut utilizing advanced composites and manufacturing techniques.

### Background of the Invention

Struts of the present invention can be aerospace components including landing gear brake rods, stay bars, linkages and wingbox structural components to name a few. Metal components are currently used due to reliability and proven lifespan; however, composite materials are desired for weight reduction. Partial composite components are used for some components such as brake rods but include metal end fittings. The disadvantage with metal end fittings in any composite solution is the inherent weak point, stiffness mismatch and CTE (coefficient of thermal expansion) mismatch at the metal-composite joint. Such a joint with metal ends and its inherently different stiffnesses between materials is a source of fatigue failure. Furthermore, this does not allow the full use of the composite's strength because the continuous composite fiber is cut at a joint.

U.S. Pat. No. 10,464,656 shows metal end fittings which suffer the problems as previously explained. The single shear bond (as identified in claim 11 and column 2, lines 27-32 of the '656 Patent) between the composite tube and metal end fitting is a weak point that the present invention overcomes.

U.S. Patent Publication 2005/0056117 uses a conventional filament winding operation that is not optimized for strength due to alignment of the fibers. After the strut body is wound then its forked ends are formed with openings designed to receive load transfer inserts.

Accordingly, there still exists a need for even lighter and stronger struts that can ultimately lead to substantial weight savings, especially considering the numerous amounts of struts that may be utilized in a particular vehicle, such as an airplane. The present invention fulfills these needs and provides other related advantages.

### SUMMARY OF THE INVENTION

The solution of the present invention is a continuous reinforced composite strut. The strut of the present invention has an integrated composite end to withstand the load with minimal, if any, metal in the entire structure. The present invention solves the problem of heavyweight and complicated designed metal end components usually required for highly loaded structural elements. The continuous reinforced composite strut offers sufficient mechanical strength and stiffness, while reducing component weight significantly, by ½ or up to a ⅔ weight reduction.

The present invention allows continuous fibers to traverse the entire length of the structural element without cutting the fiber and puts the composite fibers in the direction of load, as well as in-plane loading along the main section. At the ends, the composite strut is put in a load scenario ideal for it, i.e., with thru-wall compression. With this, load can be transferred from a separate component, a metal pin for example, from out-of-plane stress into the composite and then to in-plane stress within the composite along the length of the component. This is different than usual joints which require metal and require to shear in the load causing high interlaminar and damaging loads to the composite. This invention avoids that problem altogether and takes thru-wall out-of-plane stress at the ends and directly loads the fibers in-plane.

The process of the present invention utilizes robotic fiber placement of continuous fiber thermoplastic composites to place a continuous fiber tape, continuously around both ends of a structural linkage. This, plus internal composite components to help boost compression and torsion loads on the linkage, are the essence of the invention that is unmatched to date. The composite is in its ideal load state, with minimal interlaminar loading compared to in-plane loading, and limited distortional loading compared to in-plane loading. This cannot be accomplished with metal end fittings and cutting fibers as done with traditional composite designs.

U.S. Publication 2005/0056117 uses a filament winding, whereas the present invention uses fiber placing in-situ (on the fly melt processed) bringing inherent different properties. With the present invention no post process heat cycle is required. A heat cycle allows materials with different thermal expansion rates to grow and shrink back at different rates upon return to room temperature, allowing them to become de-bonded.

Tension winding during the in-situ fiber placement process can be employed to prestress the strut, reducing deflection along axis of strut, the primary load direction, during service. With no post-processing, as required with thermoset materials under tension winding, the strut does not change dimensions as it cycles through high temperatures, as it would with thermoset based material. This is unique to in-situ AFP of thermoplastic CFRPs (carbon fiber-reinforced plastics).

An exemplary embodiment of a composite strut, includes: a first end opposite a second end separated by a strut distance along a longitudinal axis, the first end defining a first aperture and the second end defining a second aperture; a compression block extending along the longitudinal axis disposed between the first aperture and the second aperture, the compression block defining a top side opposite a bottom side disposed between a right side opposite a left side; a tension strap comprising a first continuous fiber reinforced plastic composite wrapped repeatedly around the first aperture, along the top side of the compression block, around the second aperture and along the bottom side of the compression block at least two times, wherein fibers of the tension strap are oriented extending parallel to the longitudinal axis between the first and second apertures; and an overwind comprising a second continuous fiber reinforced plastic composite wrapped repeatedly around the first continuous fiber reinforced plastic composite and the compression block between the first end and second end at least two times, wherein fibers of the overwind are oriented extending around the longitudinal axis.

Other exemplary embodiments may include a left side filler block extending along the longitudinal axis between the first and the second apertures disposed between the compression block and the overwind on the left side of the compression block, the left side filler block in cross section along the longitudinal axis defining a left side chord length adjacent to the left side of the compression block, the left side chord length opposite a left side curvature. Likewise, this exemplary embodiment may include a right side filler block extending along the longitudinal axis between the first and the second apertures disposed between the compression block and the overwind on the right side of the compression block, the right side filler block in cross section along the longitudinal axis defining a right side chord length adjacent to the left side of the compression block, the right side chord length opposite a right side curvature. The compression block, the left side filler block and the right side filler block may be separately manufactured parts or the compression block, the left side filler block and the right side filler block may be integrally manufactured as a single part.

The first continuous fiber reinforced plastic composite may be wrapped repeatedly at least 3 times, at least 5 times, or at least 10 times.

The compression block, tension strap and the overwind may utilize a common base resin.

A first end and a second end of the compression block may be at least partially cylindrically shaped.

The compression block may be rectangular in cross section along the longitudinal axis.

The first and the second apertures may be cylindrically shaped.

The composite strut may exclude (i.e., not comprise) any metal part throughout.

The compression block may comprise a chopped fiber filled thermoplastic composite.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an isometric view of a strut of the present invention;

FIG. 2 is a side view of the structure of FIG. 1;

FIG. 3 is an isometric view of the compression block from the structure of FIG. 1;

FIG. 4 is an isometric view of the tension strap being wrapped around the compression block utilizing two removable pins;

FIG. 5 is an isometric view of the tension strap and compression block with the removable pins removed;

FIG. 6 in an isometric view of the tension strap and compression block with two filler blocks disposed at the sides ready for an overwind to be applied; and

FIG. 7 is a cross sectional view taken from lines 7-7 from FIG. 1.

### DETAILED DESCRIPTION OF THE PREFERRED EMBODIMENTS

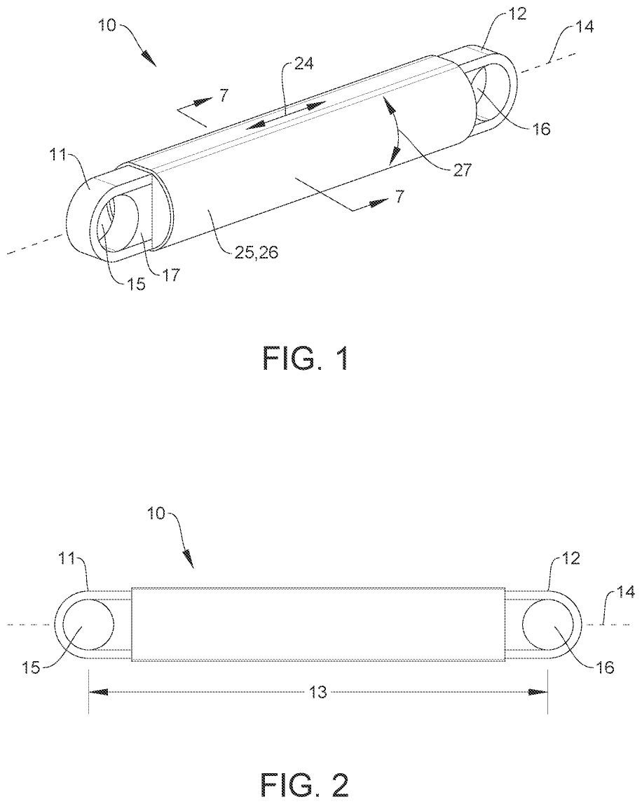

FIG. 1 is an isometric view of a strut 10 of the present invention. FIG. 2 is a side view of the structure of FIG. 1. The composite strut 10 can be defined as having a first end 11 opposite a second end 12 separated by a strut distance 13 which is along a longitudinal axis 14. The first end defines a first aperture 15 and the second end defines a second aperture 16. In this embodiment the aperture is circular but could be square, rectangular or any other suitable shape known to those skilled in the art.

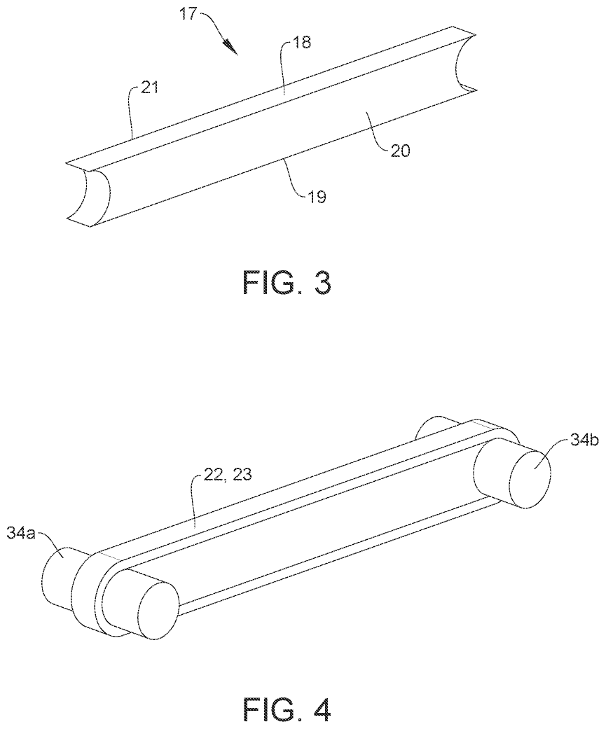

A compression block 17 extends along the longitudinal axis and is disposed between the first aperture and the second aperture. The compression block is best seen in FIG. 3 where is it shown separately in isometric view. The compression block defines a top side 18 opposite a bottom side 19 disposed between a right side 20 opposite a left side 21. The compression block is the first part that would be made in the present invention. The compression block could be made via compression molding or other long thermal soak operations, preferably with continuous fibers oriented in the direction of the load (axially) using thermoplastic composite of the same type as the tension strap thereby allowing melt bonding during in-situ fiber placement of the tension strap.

As best shown in FIG. 4, a tension strap 22 is wrapped around the compression block and can utilize two removable pins 34a and 34b. The tension strap is a continuous fiber reinforced plastic composite 23 which is wrapped repeatedly around the first aperture, along the top side of the compression block, around the second aperture and along the bottom side of the compression block at least two times. In reality, the tension strap is wrapped a multitude of times, such as at least 3 times, at least 5 times, at least 10 times or any number “n” of times to achieve the desired strength. As best shown in FIG. 1, the fibers of the tension strap are oriented extending parallel 24 to the longitudinal axis between the first and second apertures. This means the fibers are oriented in their best direction to achieve an optimal amount of strength.

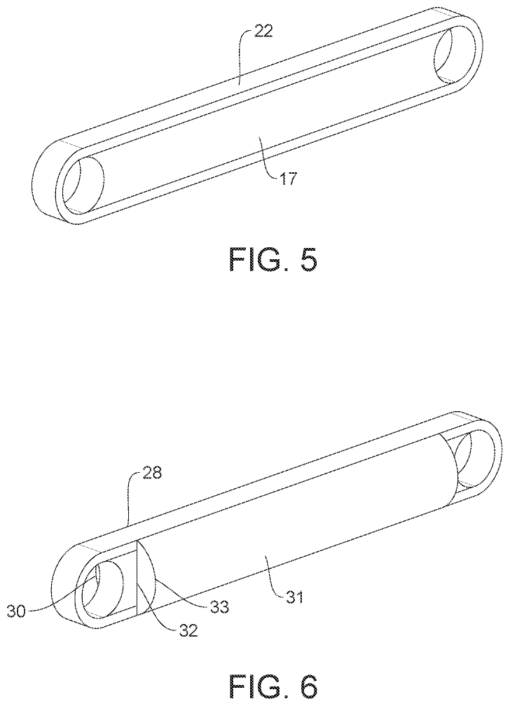

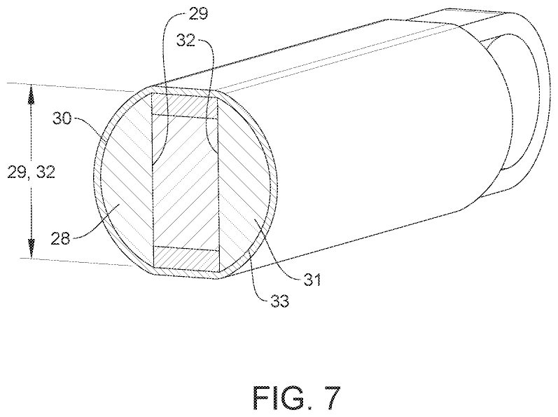

FIG. 5 shows the two removeable pins have been removed. FIG. 6 shows a left side filler block 28 (mostly hidden) and a right side filler block 31. The filler blocks can also be seen in the cross section shown in FIG. 7. The left side filler block extends along the longitudinal axis between the first and the second apertures disposed between the compression block and an eventual overwind on the left side of the compression block. The left side filler block in cross section along the longitudinal axis defining a left side chord length 29 adjacent to the left side of the compression block. The left side chord length is opposite a left side curvature 30. The left side curvature in this embodiment is circular in shape, but could be any arc or suitable curve that provides a smooth transition for the eventual overwind, which is later discussed.

Similarly, the right side filler block 31 extends along the longitudinal axis between the first and the second apertures disposed between the compression block and the overwind on the right side of the compression block. The right side filler block in cross section along the longitudinal axis defines a right side chord length 32 adjacent to the left side of the compression block. The right side chord length is opposite a right side curvature 33, which is similarly circular in shape.

Referring to FIGS. 1 and 7, an overwind 25 comprises a second continuous fiber reinforced plastic composite 26 wrapped repeatedly around the first continuous fiber reinforced plastic composite and the compression block between the first end and second end at least two times. Again, the number of wrappings could be any “n” number of wrapping needed to achieve the desired strength. The fibers of the overwind are oriented extending around 27 the longitudinal axis.

In this embodiment, the compression block, the left side filler block and the right side filler block are separately manufactured parts. However, in an alternative embodiment the compression block, the left side filler block and the right side filler block may be integrally manufactured as a single part.

The compression block, tension strap and the overwind utilize a common base resin. This aids in preventing delamination and reduces and/or eliminates any mismatches between coefficients of thermal expansion.

In this embodiment, the compression block is rectangular in cross section along the longitudinal axis. However, other shapes could be used such as square or octagonal, as an octagonal shape would incorporate the left and right side filler blocks.

The composite strut of claim 1, wherein the compression block may comprise a chopped fiber filled thermoplastic composite.

In this embodiment, the entire strut does not comprise a metal part.

Although several embodiments have been described in detail for purposes of illustration, various modifications may be made to each without departing from the scope and spirit of the invention. Accordingly, the invention is not to be limited, except as by the appended claims.

### NUMERALS

10 strut

11 first end, strut

12 second end, strut

13 distance, strut

14 longitudinal axis, strut

15 first aperture

16 second aperture

17 compression block

18 top side, compression block

19 bottom side, compression block

20 right side, compression block

21 left side, compression block

22 tension strap

23 first continuous fiber reinforced plastic composite

24 orientation parallel to longitudinal axis

25 overwind

26 second continuous fiber reinforced plastic composite

27 oriented extending around longitudinal axis

28 left side filler block

29 left side chord length, left side filler block

30 left side curvature, left side filler block

31 right side filler block

32 right side chord length, right side filler block

33 right side curvature, right side filler block

34 removable pins

What is claimed is:

1. A composite strut, comprising:
a first end opposite a second end separated by a strut distance along a longitudinal axis, the first end defining a first aperture and the second end defining a second aperture;
a compression block extending along the longitudinal axis disposed between the first aperture and the second aperture, the compression block defining a top side opposite a bottom side disposed between a right side opposite a left side;
a tension strap comprising a first continuous fiber reinforced plastic composite wrapped repeatedly around the first aperture, along the top side of the compression block, around the second aperture and along the bottom side of the compression block at least two times, wherein fibers of the tension strap are oriented extending parallel to the longitudinal axis between the first and second apertures; and
an overwind comprising a second continuous fiber reinforced plastic composite wrapped repeatedly around the first continuous fiber reinforced plastic composite and the compression block between the first end and second end at least two times, wherein fibers of the overwind are oriented extending around the longitudinal axis.

2. The composite strut of claim 1, including a left side filler block extending parallel to the longitudinal axis between the first and the second apertures and being disposed between the compression block and the overwind on the left side of the compression block, the left side filler block in cross section along the longitudinal axis defining a left side chord length adjacent to the left side of the compression block, the left side chord length opposite a left side curvature.

3. The composite strut of claim 2, including a right side filler block extending parallel to the longitudinal axis between the first and the second apertures and being disposed between the compression block and the overwind on the right side of the compression block, the right side filler block in cross section along the longitudinal axis defining a right side chord length adjacent to the left side of the compression block, the right side chord length opposite a right side curvature.

4. The composite strut of claim 3, wherein the compression block, the left side filler block and the right side filler block are separately manufactured parts.

5. The composite strut of claim 3, wherein the compression block, the left side filler block and the right side filler block are integrally manufactured as a single part.

6. The composite strut of claim 1, wherein the first continuous fiber reinforced plastic composite is wrapped repeatedly at least 3 times.

7. The composite strut of claim 1, wherein the first continuous fiber reinforced plastic composite is wrapped repeatedly at least 5 times.

8. The composite strut of claim 1, wherein the first continuous fiber reinforced plastic composite is wrapped repeatedly at least 10 times.

9. The composite strut of claim 1, wherein the compression block, the tension strap and the overwind utilize a common base resin.

10. The composite strut of claim 1, wherein a first end and a second end of the compression block are at least partially cylindrically shaped.

11. The composite strut of claim 1, wherein the compression block is rectangular in cross section along the longitudinal axis.

12. The composite strut of claim 1, wherein the first and the second apertures are cylindrically shaped.

13. The composite strut of claim 1, wherein the composite strut does not comprise a metal part.

14. The composite strut of claim 1, wherein the compression block comprises a chopped fiber filled thermoplastic composite.

15. A composite strut, comprising:
a first end opposite a second end separated by a strut distance along a longitudinal axis, the first end defining a first aperture and the second end defining a second aperture;
a compression block extending along the longitudinal axis disposed between the first aperture and the second aperture, the compression block defining a top side opposite a bottom side disposed between a right side opposite a left side;
a tension strap comprising a first continuous fiber reinforced plastic composite wrapped repeatedly around the first aperture, along the top side of the compression block, around the second aperture and along the bottom side of the compression block at least two times, wherein fibers of the tension strap are oriented extending parallel to the longitudinal axis between the first and second apertures;
an overwind comprising a second continuous fiber reinforced plastic composite wrapped repeatedly around the first continuous fiber reinforced plastic composite and the compression block between the first end and second end at least two times, wherein fibers of the overwind are oriented extending around the longitudinal axis;
a left side filler block extending parallel to the longitudinal axis between the first and the second apertures and being disposed between the compression block and the overwind on the left side of the compression block, the left side filler block in cross section along the longitudinal axis defining a left side chord length adjacent to the left side of the compression block, the left side chord length opposite a left side curvature;
a right side filler block extending parallel to the longitudinal axis between the first and the second apertures and being disposed between the compression block and the overwind on the right side of the compression block, the right side filler block in cross section along the longitudinal axis defining a right side chord length adjacent to the left side of the compression block, the right side chord length opposite a right side curvature;
wherein the compression block, the tension strap, the left side filler block, the right side filler block and the overwind utilize a common base resin; and
wherein the composite strut does not comprise a metal part.
